(19) United States
(12) Patent Application Publication
(10) Pub. No.: US 2016/0127146 A1
(43) Pub. Date: May 5, 2016

(54) Communicating During Data Extraction Operations

(71) Applicant: HEWLETT-PACKARD DEVELOPMENT COMPANY, L.P., HOUSTON, TX (US)

(72) Inventors: Manish Gupta, PALO ALTO, CA (US); NEEL BANERJEE, PORTLAND, OR (US); SUMIT KALA, SUNNYVALE, CA (US); ANDREAS (ANDREW) H QUEISSER, CORVALLIS, OR (US)

(21) Appl. No.: 14/441,186

(22) PCT Filed: Nov. 7, 2012
(86) PCT No.: PCT/IB2012/003110

§ 371 Date: Nov. 2, 2015

(51) Int. Cl. H04L 12/28; H04W 4/00

(52) U.S. Cl. CPC H04L 12/2827; H04W 4/005; H04L 2012/2841

(57) ABSTRACT

Communicating during data extraction operations includes establishing a first connection between a job scheduler and an extraction device with the extraction device, sending information about a sensor to the job scheduler in response to a formation of a second connection between the extraction device and the sensor, and extracting data from the sensor in response to receiving a command from a data harvester in communication with the job scheduler.

### BACKGROUND

Some networks contain hundreds of sensors. Each sensor may measure a physical parameter that is helpful for network administrators or users. To accommodate the vast amounts of information, some networks aggregate the information measured with the sensors to make the measured data easier to understand.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1a is a diagram of an example of physical architecture of extraction devices according to principles described herein.

FIG. 1b is a diagram of an example of extraction devices according to principles described herein.

FIG. 2 is a diagram of an example of a protocol for communicating during a data extraction operation according to principles described herein.

FIG. 3 is a diagram of an example of a method performed with a job scheduler according to principles described herein.

FIG. 4 is a diagram of an example of a method performed with an extraction device according to principles described herein.

FIG. 5 is a diagram of an example of a method performed with a data harvester according to principles described herein.

FIG. 6 is a diagram of an example of a method performed with a monitoring server according to principles described herein.

FIG. 7 is a diagram of an example of a method for communicating within a data extraction system according to principles described herein.

FIG. 8 is a diagram of an example of a communication system according to principles described herein.

FIG. 9 is a diagram of an example of a flowchart of a process for communicating with a data extraction system according to principles described herein.

### DETAILED DESCRIPTION

Acquiring geophysical data about subterranean structures often involves spacing multiple sensors apart from each other around the subterranean structure of interest. Each sensor records information pertaining to the structure within the sensors individual ranges. In seismic recording operations, the sensors record acoustic information over a period of time, usually over a couple of days. Often the sensors are collected and the recorded data is extracted. Each of the sensor's recorded data contributes to an overall understanding of the subterranean structure's characteristics.

Generally, when more sensors are involved in measuring a subterranean structure, the resulting understanding of the subterranean structure is more accurate and complete. In seismic surveys, thousands of sensors may be used to determine the characteristics of the subterranean structure.

The system used to retrieve the data recorded from the sensors may include thousands of individual extraction devices. Monitoring the status of each of the extraction devices may be complex due to the large volume of devices involved. To save resources, the technicians involved with the extraction process strive to download the recorded data in a minimal amount of time. Due to the large number of extraction devices, a large amount of bandwidth would be consumed if all of the recorded data were to be downloaded at once.

The principles described herein include a method for communicating during extraction operations to maximize the utilization of the available bandwidth while also minimizing the extraction process's duration. A method for communicating during data extraction operation may include establishing a first connection between a job scheduler and an extraction device with the extraction device, sending information about a sensor to the job scheduler in response to a formation of a second connection between the extraction device and the sensor, and extracting data from the sensor in response to receiving a command from a data harvester in communication with the job scheduler.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described is included in at least that one example, but not necessarily in other examples.

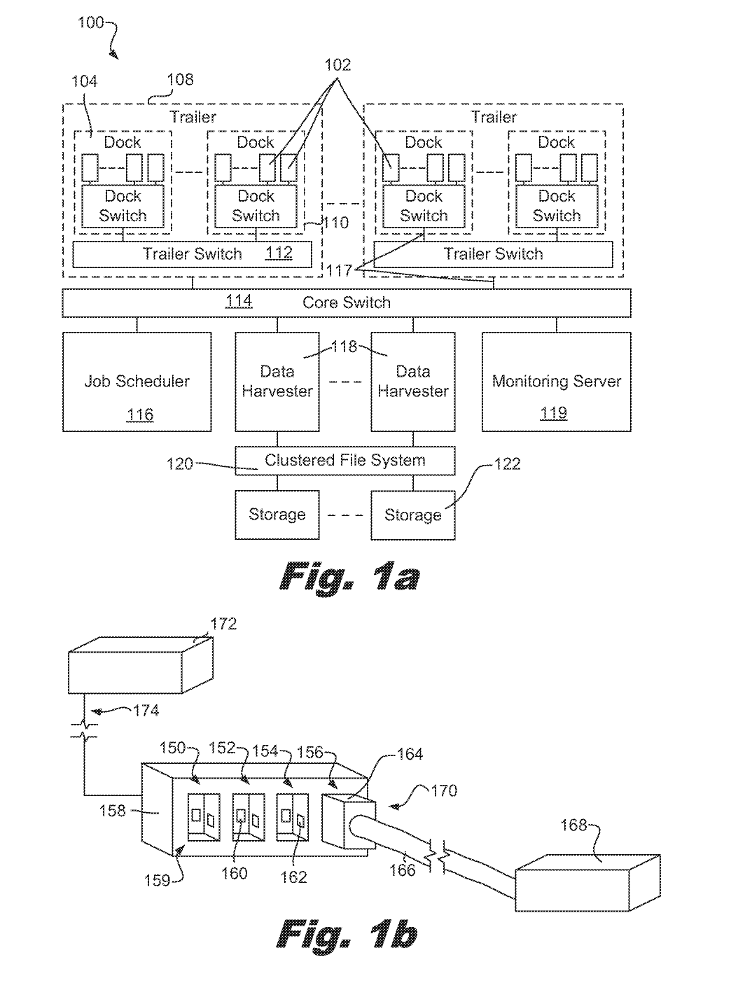

FIG. 1a is a diagram of an example of physical architecture (100) of extraction devices (102) according to principles described herein. In the illustrated example, the extraction devices (102) have receptacles that receive an end of a cable or other electrically conductive medium used to transfer data and/or power. The electrically conductive medium is in communication with a sensor. The establishment of a physical connection between the extraction device and the sensors enables the system to extract data from the sensors. The data is downloaded from a sensor of seismic survey or other network. In other examples, the extraction device is a wireless transceiver or other apparatus capable of receiving data. A non-exhaustive list of extraction devices (102) may include Ethernet ports, cable ports, wireless devices, short wave receivers, internet protocol addresses ports, dock pockets, inductive couplers, other extraction devices, or combinations thereof. The electrically conductive medium may make physical contact with an electrical contact of the extraction device which enables the extraction device to send electrical power to the sensors to charge the sensor during an extraction process. In other examples, electrical power is passed through the physical connection, but the extracted data is passed wirelessly.

In some examples, the extraction devices (102) include a circuit board within the receptacle that wirelessly communicates with the sensors. Also, the circuit board includes a mechanism that senses when the end of the electrically conductive medium is inserted into the receptacle. In some examples, the circuit board includes a mechanism that senses when a sensor is inserted into the extraction device. In response to the insertion of the end of the electrically conductive medium, the extraction device (102) sends information to a distributed server subsystem that orchestrates the extraction process.

In the example of FIG. 1a, the extraction devices (102) are grouped together into docks (104). As a result, multiple data exchanging media are inserted side by side to each other. Thus, multiple sensors download recorded data simultaneously. Further, the physical architecture (100) includes the docks being arranged in trailers (108). The physical architecture (100) has at least one trailer (108). As a specific example, a physical architecture (100) of extraction devices (102) for a seismic survey has five trailers with two rows of ten docks each. In such an example, the docks (104) each have eight rows and six columns of extraction devices totaling 48 extractions devices per dock. In this example, the system uses a total 4,800 extraction devices.

A dock switch (110) is used to direct communications to the desired extraction device (102). Further, a trailer switch (112) is used to direct communications intended for the extraction devices to the appropriate dock (104). Also, a core switch (114) is used to direct communications intended for the extraction devices to the appropriate trailer, In the example of FIG. 1a, the core switch (114) also directs communications from the extraction devices to components of the distributed server subsystem.

A job scheduler (116) of the distributed server subsystem is in communication with the extraction devices through hardwired links (117) and the switches (110, 112, 114). The job scheduler (116) schedules times for when each of the extraction devices are to extract the recorded data from each sensor. In examples where hundreds or thousands of extraction devices are to extract data, the job scheduler coordinates the extraction of data from each sensor such that the system operates at its maximum efficiency. In some examples, the physical architecture's bandwidth capabilities limit the system's ability to extract all of the data at once. In other examples, processor speeds, switching speeds, other conditions, or combinations thereof prevent each of the extraction devices from extracting the recorded data simultaneously.

Data harvesters (118) of the distributed server subsystem are used to receive the recorded data. The data harvester (118) requests the recorded data to be extracted from the extraction devices at a time or in a sequence that the job scheduler (116) designates. The data harvester (118) filters the data to remove predetermined data. For example, the predetermined data may be unreadable data, repetitive data, corrupted data, other forms of data, or combinations thereof that are removed from the raw data harvested from the sensors. This filter processing maximizes storage space. In some examples, the data harvester (118) also causes the recorded data to be processed in other ways. For example, if the recorded data is unstructured, and the data harvester (118) can format the data. In some examples, the data harvester (118) compresses the data, cleans the data, validates the data, performs other processes on the data, or combinations thereof.

In some examples, the job scheduler (116) and data harvesters (118) communicate with each other through the core switch (114). Further, a monitoring server (119) can also he in communication with the job scheduler (116) and the data harvesters (118) through the core switch (114).

In some examples, the data harvester (118) sends the data to a clustered file system (120) where each of the data harvesters may deposit the recorded data. In some examples, the data harvesters (118) validate and/or modify the recorded data before placing the recorded data into the clustered file system (120). In other examples, the data harvesters (118) modify the recorded data after the data is saved to the clustered file system (120).

The data harvester (118) sends the recorded data to memory storage (122) directly, or in some examples, the data harvesters (118) cause the recorded data to be sent to memory storage (122) from the clustered file system (120). The storage may be physical storage, non-transitory storage, random access memory, non-volatile memory, volatile memory, flash memory, memristor based memory, a computer readable storage medium, other forms of memory, or combinations thereof. Researchers or computer programs read the recorded data from the storage (122) for further processing and analysis.

The monitoring server (119) queries the extraction devices (102) and/or sensors to determine their status information. In this manner, the monitoring server (119) tracks the conditions of the sensors and the extraction devices (102) and make adjustments or send out alerts as deemed appropriate. The monitoring server (119) may send updates or code patches to fix issues during the extraction process.

The time needed to download the recorded data from each sensor varies from less than a minute to a couple of hours. Thus, to reduce the extraction process time, multiple sensors are connected to the extraction devices at the same time and download their recorded data simultaneously.

In some examples, a user has an ability to initially connect all of the sensors of a survey to the extraction devices. The system may be able to extract data from just a subset of the sensors at the same time. Thus, the system includes an extraction job scheduler that coordinates when the recorded data from each of the sensors is extracted. The system may begin downloading recorded data from some of the sensors while the user continues to connect other sensors to the extraction devices. As a result, the total extraction process time is reduced because the system uses the time that a user is installing some of the sensors to download the data from those sensors that are already installed. In another example, data is extracted from just a subset of the sensors deployed in the survey in a day. The number of sensors from which data is extracted is based on the daily movement of the sensors, available extraction devices, download rates of the extraction devices, and the number of shifts being run in a day.

The recorded data may be seismic data from a seismic survey that contains information that was recorded over a period of time, usually a couple of days. In such an example, sensors are placed or laid against an earthen surface adjacent to a subterranean formation of interest. In some examples, the sensors are placed in an open borehole and pushed firmly against the borehole. In other examples, the sensors are placed on top of dry ground. Yet, in other examples, the sensors are placed on the floor of a body of water that is over the subterranean structure of interest. Further, the sensors may be towed in lines behind a boat or other water vessel. In some examples, the seismic survey is a three-dimensional seismic survey that records acoustic information from a formation, but records for a shorter amount of time. The recorded acoustic information may be generated with an acoustic source that is purposefully activated near the subterranean structure of interest to generate acoustic waves that travel through the structure. The acoustic source is a drill string jarring mechanism, an explosive, a hammering mechanism, another acoustic source, or combinations thereof. The characteristics of the formation affect the time and angle that acoustic signals arrive at the sensors. This data is recorded with the sensors and is downloaded with the extraction devices for analysis by experts to determine the subterranean structure's characteristics.

In other examples, other forms of data in geophysical applications are recorded with the sensors. For example, electrical data, density data, buoyancy data, thermal data, pressure data, radioactivity data, chemical data, magnetic data, or other forms of data, or combinations thereof may be recorded. The data is used to determine a subterranean formation's potential for oil, gas, geothermal, mineral, or other payload potential, or combinations thereof.

Initial testing of the principles described herein indicates that the system can extract data within the targeted time goals. For example, recorded data that was extracted from thousands of sensors used in a seismic survey were downloaded within the targeted goal of four hours.

The physical architecture (100) is in communication with a monitor that is set up to display at least one type of status information about the extraction devices (102), the sensors, or combinations thereof. The monitor may be set up to display additional information about the extraction devices and/or information about the data that is being extracted.

While the examples above have been described with specific devices communicating with specific components, the devices of the system may be in communication with other components. For example, the data harvester (118) may be in communication with a climate controller. The data harvester (118) or other component of the system may calculate current and future climate needs of the data harvester, the sensors, the extraction devices (102), docks (104), trailer (108) or other components. The determination may include determining how much heat will be generated from charging the batteries, how many batteries need to be charged, how much power each battery currently has, how much heat will be lost to data extraction, how much data is to be extracted, other factors, or combinations thereof.

FIG. 1b is a diagram of an example of extraction devices (150, 152, 154, 156) according to principles described herein. In this example, a dock (158) contains the extraction devices (150, 152, 154, 156). Each extraction device (150, 152, 154, 156) has receptacles (159) with a wireless data transmitting device (160) and an electrical contact (162) for charging power to the sensor's batteries. An end (164) of an electrically conductive medium (166) is inserted into the receptacle of extraction device (156). In this example, the electrically conductive medium is in communication with the sensor (168) forming a physical connection (170) between the sensor (168) and extraction device (156).

When the end (164) is inserted into the extraction device's receptacle (159), the end makes a physical electrical connection with the electrical contact (162). The electrical contact is capable of transmitting electrical power to charge the sensor's battery. The wireless device (160) is in communication with the electrically conductive medium to extract data from the sensor (168). In some examples, the data extraction and charging tasks occur simultaneously. In other examples, these tasks occur sequentially.

The wireless data transmitting device (160) may be a circuit board with an integrated circuit. The circuit may be capable of wireless data exchange. In some examples, the circuit board has a microprocessor that sends and receives messages with other components of the system, such as servers that are used in data extraction operations.

The dock (158) is in communication with at least one server. In the example of FIG. 1b, the dock (158) is in communication with a server (172) that performs the task of scheduling extraction jobs for the data harvester. The extraction device (156) forms a network connection (174) with the server (172) prior to the insertion of the end (164) into the receptacle (159). In other examples, the network connection is formed in response to the formation of the physical connection (170) between the sensor (168) and the extraction device (156).

The sensors (168) may have any amount of recorded data to download. In examples where the sensors are used to record geophysical data for the course of several days, each sensor may contain multiple gigabytes of recorded data.

The server (172) is in communication with each of the extraction devices. The system may be an end to end network of extraction devices and servers, where information and recorded data may be routed from any server to any extraction device or vice versa.

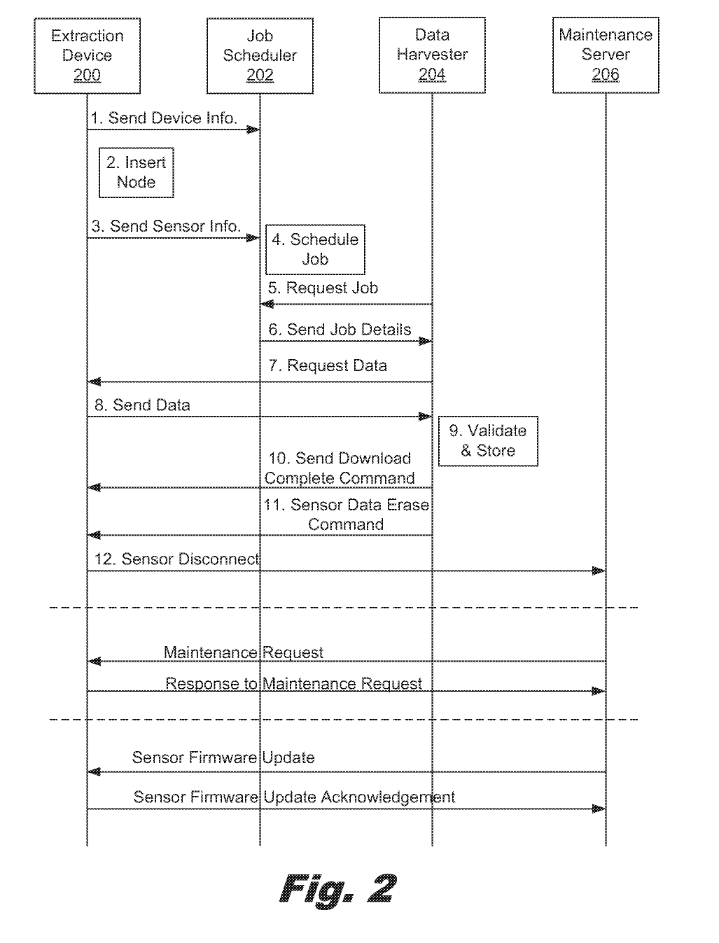

FIG. 2 is a diagram of an example of a protocol for communicating during a data extraction operation according to principles described herein. In this example, an extraction device (200) initiates a first connection between the extraction device (200) and a job scheduler (202) prior to the establishment of a second connection between the extraction device and a sensor. The second connection may be created by a user that inserts an end of an electrically conductive medium connected to a sensor into a receptacle of the data extraction device (200). The extraction device (200) may initiate the first connection between the extraction device and the job scheduler after the second connection is already established.

After the first connection is established, the extraction device sends extraction device specific information to the job scheduler (202). For example, the specific information includes identifying information that allows the job scheduler (202) to schedule the appropriate extraction device (200).

After sending the extraction device (200) specific information, the extraction device (200) sends the sensor specific information to the job scheduler (202). In response to receiving the sensor specific information, the job scheduler (202) schedules a time or a sequence to extract the data from the sensor. The job scheduler (202) determines the extraction time or sequence based on a policy that is based on a first-in-time consideration, a priority consideration, an amount of data to be extracted consideration, other considerations, or combinations thereof. In some examples, the job scheduler (202) schedules a sequence of jobs instead of scheduling a specific time. In such a manner, the job scheduler (202) does not need to consider how long an extraction job per each sensor will take. For example, the job scheduler (202) determines that the system has the capacity to download fifty extraction devices simultaneously and accordingly schedule the first fifty extraction devices to extract the recorded data upon request. The job scheduler (202) may schedule the fifty-first extraction device to extract upon the completion of the extraction of one of the extraction devices, the fifty-second extraction device to extract when the next extraction device finishes, and so forth.

A data harvester (204) requests a job from the job scheduler (202) when the data harvester (204) has capacity to perform a job. The job scheduler (202) sends the data harvester (204) details about the next scheduled job. The details may include the specific extraction device information and the specific sensor information associated with the next job. The data harvester (204) sends a request to the appropriate extraction device (200) for the recorded data. In response to the request, the extraction device (200) sends the recorded data to the data harvester (204).

The data harvester (204) validates the received recorded data and sends the recorded data to memory storage. In response to completing the extraction job, the data harvester (204) sends to the extraction device (200) a download complete message and a command to erase the data in the sensor. By erasing the data in the sensor, the sensor becomes ready to record more data.

The extraction device sends a current status update of the sensor to the monitoring device at regular intervals. So, the monitoring server will be notified that the data in the sensors is erased. Once the sensor is charged to the desired amount after the data is erased, the sensor is ready for redeployment.

The maintenance server (206) may perform other tasks to evaluate the sensor. For example, the maintenance server (206) may send a maintenance request to the sensor, via the extraction device, to elicit an operating condition of the sensor. In response to receiving the sensor's information, the extraction device may send the requested information. In some examples, the maintenance server (206) sends updates for the sensor. The maintenance server (206) may track which sensors have received the updates or automatically send the update to all sensors without tracking which sensors have received the update. In response to receiving the updates, the extraction device (200) may send an acknowledgement. In other examples, the maintenance server (206) may cause other procedures to occur for the sensor and/or extraction device (200). In some examples, the maintenance server (206) requests different types of information from the sensor and/or extraction device (200).

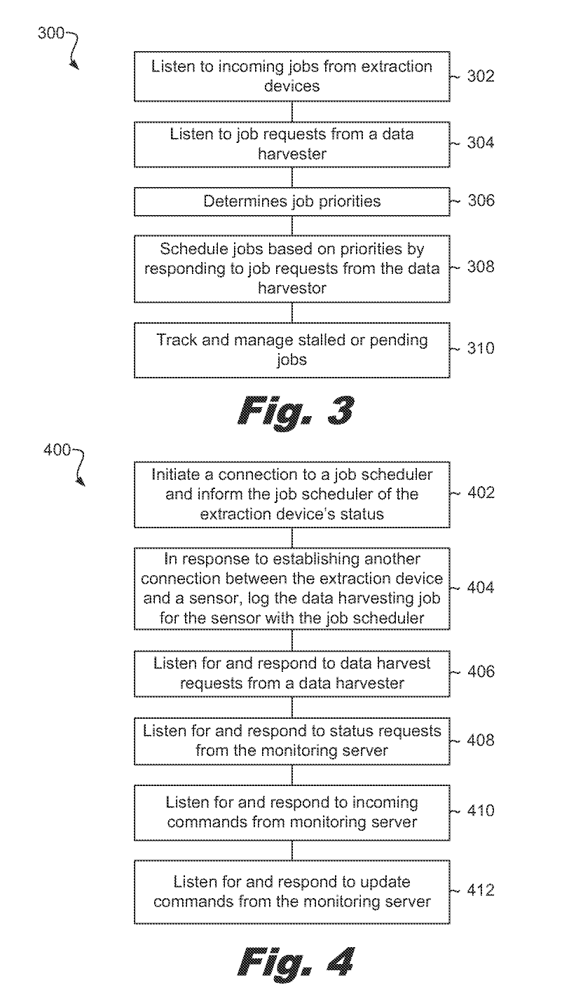

FIG. 3 is a diagram of an example of a method (300) performed with a job scheduler according to the principles described herein. In this example, the method (300) includes listening (302) to incoming jobs from the extraction devices, listening (304) to job requests from a data harvester, determining (306) job priorities, scheduling (308) jobs based on priorities by responding to job requests from the data harvester, and tracking (310) and managing stalled or pending jobs.

The job scheduler may be a server or a component of a server. In other examples, the job scheduler is a server in a distributed server subsystem. The job scheduler may schedule a specific time for each of the extraction devices to extract data. In other examples, the job scheduler schedules a specific sequence in which the extraction devices are to extract the data. The job scheduler may base the schedule on a policy and/or at least one consideration. In examples where the job scheduler schedules the extraction jobs based on policies, the policies may consider first-in-time considerations, priority data considerations, volume data to extract considerations, other considerations, or combinations thereof.

FIG. 4 is a diagram of an example of a method (400) performed with an extraction device according to principles described herein. In this example, the method (400) includes initiating (402) a connection to a job scheduler and informing the job scheduler of the extraction device's status, logging (404) the data harvesting job from the sensor with the job scheduler in response to establishing another connection between the extraction device and the sensor, listening (406) for and responding to data harvest requests from a data harvester, listening (408) for and responding to status requests from the monitoring server, listening (410) for and responding to incoming commands from monitoring servers, and listening (412) for and responding to update commands from the monitoring servers.

The extraction device may initiate the extraction process by informing a distributed server subsystem that includes dedicated servers for the job scheduling, data harvesting, and monitoring sensor and/or extraction devices. In some examples, the extraction device sends specific extraction device information that is unique to the extraction device and sensor specific information that is unique to the sensor to the distributed server subsystem to initiate the extraction process. In response to the extraction device's initiation of the extraction process, the distributed server subsystem may orchestrate the rest of the process. In some examples, at least some functionality of job scheduling, data harvesting, and monitoring are performed with a single server.

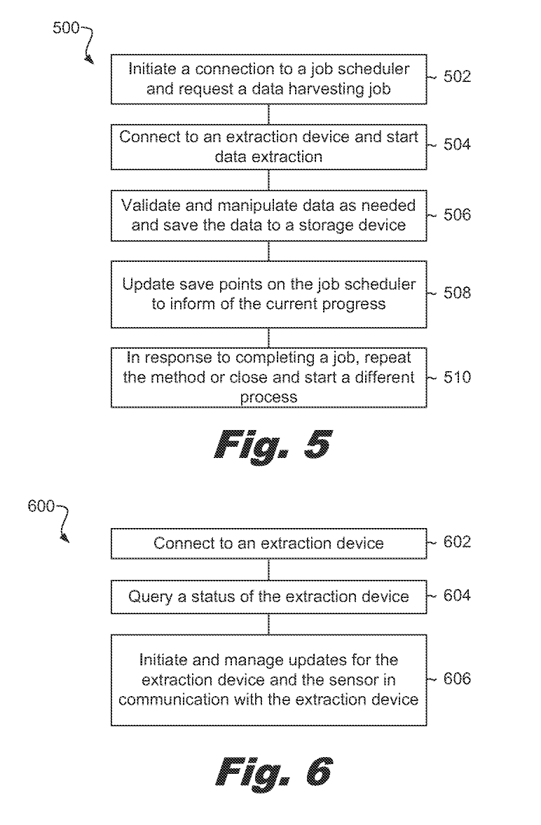

FIG. 5 is a diagram of an example of a method (500) performed with a data harvester according to principles described herein. In this example, the method (500) includes initiating (502) a connection to a job scheduler and requesting a data harvesting job; connecting (504) to an extraction device and starting data extraction; validating (506), manipulating data as needed, and saving the data to a storage device; updating (508) save points on the job scheduler to inform the job scheduler of the current progress; and repeating (510) the method with another extraction device in response to completing the job with the current extraction device. In other examples, the method includes closing the process and starting a different process.

The data harvester's functionality may be managed with at least one server. In alternative examples, the data harvester is part of a distributed server subsystem that orchestrates the extraction process. The data harvester may modify the extracted data by formatting it, filtering it, compressing it, or modifying the data in other ways, or combinations thereof.

FIG. 6 is a diagram of an example of a method (600) performed with a maintenance server according to principles described herein. In this example, the method (600) includes connecting (602) to an extraction device, querying (604) a status of the extraction device, and initiating (606) and managing updates for the extraction device's code or components and the sensor in communication with the extraction device.

The maintenance server may monitor other aspects of the sensor and/or extraction device. For example, the maintenance server may recognize an unhealthy condition of the sensor and/or extraction device, cause the extraction process for that pair of extraction device and sensor to stop, and send an alert to a user. In some examples, the maintenance server recognizes that the performance of the extraction device and/or sensor is suboptimal. In such an example, the maintenance server may send a message to the job scheduler and/or data harvester to halt the extraction process while the maintenance server alerts the user or sends an update or a code patch to improve the extraction performance. In some examples, an unhealthy condition includes overheating, slow data transfer rate, ineffective charging, other conditions, or combinations thereof.

The extraction device and the sensor may be involved in multiple tasks. For example, the data may be extracted from the sensor while the sensor's battery is also charging. In such a situation, one of the tasks may be completed before the other. For example, the data harvester may finish extracting all of the recorded data before the sensor is fully recharged. In such a situation, the maintenance server may update the job scheduler and/or data harvester that a connection should continue and some bandwidth, for example for exchanging monitoring data, should remain available while the rest of the tasks are completed.

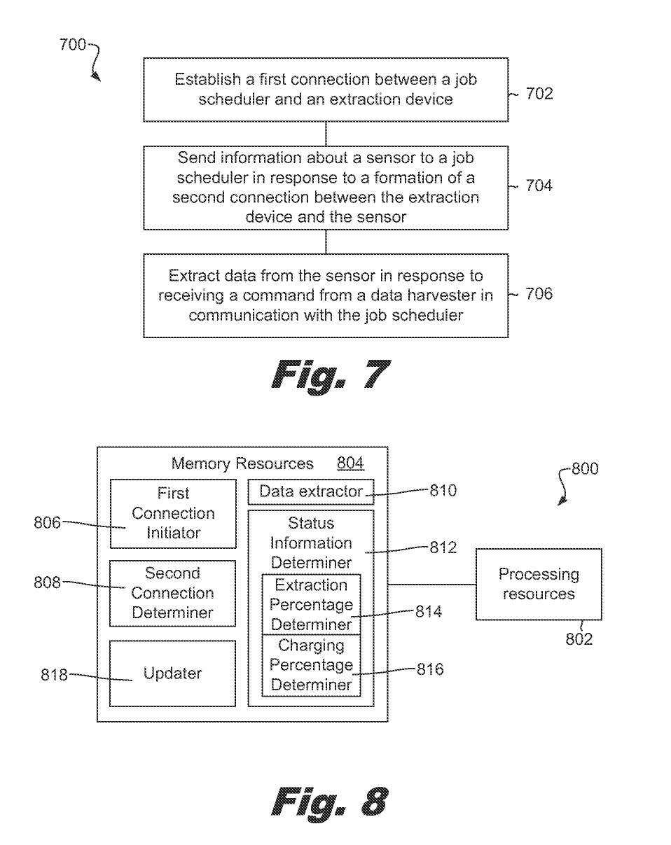

FIG. 7 is a diagram of an example of a method (700) for communicating within a data extraction system according to principles described herein. In this example, the method (700) includes establishing (702) a first connection between a job scheduler and an extraction device, sending (704) information about a sensor to a job scheduler in response to a formation of a second connection between the extraction device and the sensor, and extracting (706) data from the sensor in response to receiving a command from a data harvester in communication with a job scheduler.

The method may also include sending status information to a monitoring server in response to receiving a request from the monitoring server. The status information may include a charging percentage of the sensor, an extraction percentage of the recorded data associated with the sensor, temperature of the sensor and/or extraction device, data transfer rate, sensor specific status information, extraction device specific status information, other status information, or combinations thereof. In some examples, the status information is displayed visually.

The method may include updating the sensor in response to receiving an update command from the monitoring server. In some examples, the sensor receives the update from the monitoring server, or the sensor queries another device in the distributed server subsystem, over a network, the internet, or a combination thereof to retrieve the update sent with the monitoring server.

The first connection between the job scheduler and the extraction device may be established with the extraction device. In examples where the extraction device has receptacles that receive an end of an electrically conductive medium, the extraction device may initiate the extraction process in response to an insertion of an end of the electrically conductive medium into the receptacle. In examples where the extraction device has a wireless component, the extraction device may initiate the extraction process in response to the sensor being within a predetermined range from the extraction device.

FIG. 8 is a diagram of an example of a communication system (800) according to principles described herein. In this example, the communication system (800) includes processing resources (802) that are in communication with memory resources (804). Processing resources (802) include at least one processor and other resources used to process programmed instructions. The memory resources (804) represent general any memory capable of storing data such as programmed instructions or data structures used by the communication system (800). The programmed instructions shown stored in the memory resources (804) include a first connection initiator (806), a second connection determiner (808), an updater (818), a data extractor (810), a status information determiner (812), an extraction percentage determiner (814), and a charging percentage determiner (816).

The memory resources (804) include a computer readable storage medium that contains computer readable program code to cause tasks to be executed by the processing resources (802). The computer readable storage medium may be tangible and/or non-transitory storage medium. A non-exhaustive list of computer readable storage medium types includes non-volatile memory, volatile memory, random access memory, memristor based memory, write only memory, flash memory, electrically erasable program read only memory, or types of memory, or combinations thereof.

The first connection initiator (806) represents programmed instructions that, when executed, cause the processing resources (802) to initiate a connection between the data extraction device and a job scheduler. A second connection determiner (808) represents programmed instructions that, when executed, cause the processing resources (802) to determine when a connection between the data extractor and the sensor is established. In response to the formation of the second connection, the processing resources (802) cause information about the connected sensor to he sent to the job scheduler.

In response to a request from a data harvester, the job scheduler instructs the data harvester on which job to perform next. The job scheduler tells the data harvester on which extraction device and sensor to perform the extraction. The job scheduler may also give the data harvester additional information about the job to be performed, such as which type of data to extract, how much data to extract, permissible bandwidth usage, policy instructions, compression instructions, filtering instructions, other instructions, or combinations thereof.

The data harvester may request the recorded data as instructed by the job scheduler from the extraction device. The data extractor (810) represents programmed instructions that, when executed, cause the processing resources (802) to send the sensor's recorded data to the data harvester where the recorded data will be validated and saved to memory storage.

In some examples, a monitoring server requests status information from the processor (800) about the extraction device and/or the sensor. In response to such a request, the processor (800) causes a status information determiner (812) to determine the status of the requested information. The status information determiner (812) represents programmed instructions and has instructions that, when executed, determine specific types of status information. For example, the status information determiner (812) includes an extraction percentage determiner (814) which represent instructions, when executed, cause the processing resources (802) to determine the percentage of data already extracted from the sensor. Also, the status information determiner (812) may include a charging percentage determiner (816) which represent instructions that, when executed, cause the processing resources (802) to determine how much charge the sensor's battery has. In other examples, the status information determiner (812) has other sub-determiners that determine other types of information. In response to determining the status information requested, the communication system (800) sends the information to the monitoring server.

A maintenance server or other device sends updates for the extraction device and/or the sensor. In some examples, the maintenance server queries the extraction device and/or sensor to determine if any updates are needed. In response to determining that the extraction device and/or sensor does not have a particular update, the maintenance server sends the update to the processor (800). The communication system (800) causes the extraction device's and/or the sensor's code or components to be updated with an updater (818).

Further, the memory resources (804) may be part of an installation package. In response to installing the installation package, the programmed instructions of the memory resources (804) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (802) and the memory resources (804) are located within the same physical component, such as a server, or a network component. The memory resources (804) may be part of the physical component's main memory, caches, registers, non-volatile memory, or elsewhere in the physical component's memory hierarchy. Alternatively, the memory resources (804) may be in communication with the processing resources (802) over a network. Further, the data structures, such as the libraries may be accessed from a remote location over a network connection while the programmed instructions are located locally. Thus, the communication system (800) may be implemented on a user device, on a server, on a collection of servers, or combinations thereof.

The communication system (800) of FIG. 8 may be part of a general purpose computer. However, in alternative examples, the communication system (800) is part of an application specific integrated circuit.

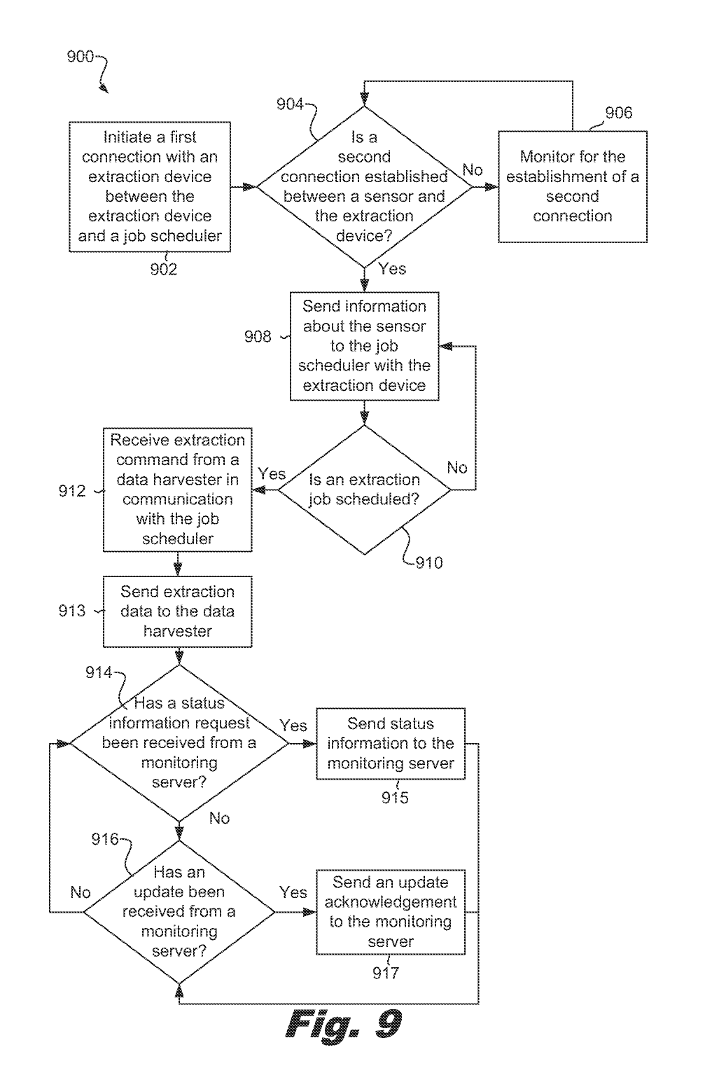

FIG. 9 is a diagram of an example of a flowchart (900) of a process for communicating with a data extraction system according to principles described herein. In this example, the process includes initiating (902) a first connection with an extraction device between the extraction device and a job scheduler. The process determines (904) whether there is a second connection established between a sensor and the extraction device. If there is no such connection established, then the process includes monitoring (906) for the establishment of that connection. If the second connection does exist, then the extraction device sends (908) information about the sensor to the job scheduler.

In response to sending the sensor's information to the job scheduler, the process includes determining (910) whether an extraction job for the sensor is scheduled. If the job is not scheduled, then the extraction device resends (908) the information to the job scheduler. If the extraction job is scheduled, then the extraction device waits until the extraction device receives (912) an extraction command from a data harvester in communication with the job scheduler. In response to receiving the command, the extraction device sends (913) the sensor's information to the data harvester.

The process also includes determining (914) whether the extraction device has received a status information request from a monitoring server. If so, then the extraction device sends (915) the status information to the requesting server. If the request has not been received, then the process includes determining (916) whether an update has been received from a monitoring server. If the update has been received, then the extraction device sends (917) the monitoring server an acknowledgement. If an update has not been received, then the process repeats determining (914) whether the extraction device has received a status information request.

In some examples, the process also includes determining whether the extraction process is complete. If so, the extraction device sends a completion notice to the data harvester and request permission to break the connection, if the request is granted, the extraction device disconnects from the data harvester. Then, the operator can remove the sensor from the extraction device and replace it with a new sensor. These process repeats itself until all of the data from all of the sensors is extracted.

While the examples above have been described in relation to extracting data from geophysical surveys, the sensors from which the data is extracted may be part of any type of network or sensors. Such networks may be corporate networks, health monitoring networks, environmental networks, surveillance networks, security networks, research networks, equipment maintenance networks, extraterrestrial monitoring networks, building maintenance networks, other networks, or combinations thereof.

While the examples above have been described with reference to specific numbers of docks, trailers, extractions devices, and sensors, any number of docks, trailers, extractions devices, and sensors may be used according to the principles described herein. Further, while the examples above have been described with specific numbers of job schedulers, data harvesters, monitoring servers, and other components of the system, any number of job schedulers, data harvesters, monitoring servers, and other components of the system may be used in accordance with the principles described herein.

While specific charging mechanisms and data extraction mechanisms have been described in connection with the above examples, any charging system or data extraction system compatible with the principles described herein may be used. Further, while a specific physical architecture of the extraction devices and sensors is described above, any suitable physical architecture that is compatible with the principles described herein may be used.

While the above examples have been described above with reference to specific sequences of communication events, the communication events may occur in any order that is compatible with the principles described herein. Further, in some examples, additional communication events occur while the components of the system are communicating with each other. In other examples, fewer communication events occur than those described in the examples above. In some examples, additional communication events include security events, error checking events, routing events, bandwidth reduction events, switching events, other events, or combinations thereof.

While the extraction devices, job schedulers, data harvesters, and monitoring servers have been described with specific functions, these devices may execute additional functions or share their functions with each other. In some examples, these components are part of a distributed server subsystem. However, in other examples, at least some of these functions are executed with a common server.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method for communicating during data extraction operations, comprising:
establishing a first connection between a job scheduler and an extraction device with said extraction device;
sending information about a sensor to said job scheduler in response to a formation of a second connection between said extraction device and said sensor; and
extracting data from said sensor in response to receiving a command from a data harvester in communication with said job scheduler.

2. The method of claim 1, further comprising sending status information to a monitoring server in response to receiving a request from said monitoring server.

3. The method of claim 2, wherein said status information comprises a charging percentage of said sensor.

4. The method of claim 2, wherein said status information comprises an extraction percentage of recorded data associated with said sensor.

5. The method of claim 2, wherein said status information comprises a temperature of said sensor and/or said extraction device.

6. The method of claim 1, further comprising updating said sensor in response to receiving an update command from a monitoring server.

7. The method claim 1, further comprising updating said extraction device in response to receiving an update command from a monitoring server.

8. The method of claim 1, wherein said extraction device comprises a receptacle capable of receiving an end of an electrically conductive medium and a wireless data exchange mechanism.

9. The method of claim 1, wherein establishing a first connection between a job scheduler and an extraction device with said extraction device includes initiating said first connection with said extraction device.

10. The system for communicating during data extraction operations, comprising:
a processor programmed to
establish a first connection with an extraction device between said extraction device and a job scheduler;
send information about a sensor in communication with said extraction device to said job scheduler in response to an end of an electrically conductive medium being inserted into a receptacle of said extraction device, said electrically conductive medium being in communication with said sensor;
receive a command to extract data from a data harvester in response to a schedule determined with said job scheduler;
send extracted data from said sensor to said data harvester in response to receiving said command.

11. The system of clam 10, further comprising updating said sensor and/or extraction device in response to receiving an update command from a monitoring server.

12. The system of claim 10, wherein establishing a first connection between a job scheduler and an extraction device with said extraction device includes initiating said first connection with said extraction device.

13. A computer program product, comprising:
a computer readable storage medium, said computer readable storage medium comprising computer readable program code embodied therewith, said computer readable program code comprising:
computer readable program code to initiate a first connection with an extraction device between said extraction device and a job scheduler:
computer readable program code to send information from said extraction device about a sensor in communication with said extraction device to said job scheduler; and
computer readable program code to send extracted data from said sensor to a data harvester in communication with said job scheduler in response to receiving a command from said data harvester.

14. The computer program product of claim 13, further comprising computer readable program code to send status information to a monitoring server in response to receiving a request from said monitoring server.

15. The computer program product of claim 14, wherein said status information comprises a charging percentage of said sensor, an extraction percentage of recorded data of said sensor, temperature of said sensor and/or extraction device, or combinations thereof.
